(19) United States
(12) Patent Application Publication
(10) Pub. No.: US 2004/0191517 A1
(43) Pub. Date: Sep. 30, 2004

(54) Self-assembling nanowires

(75) Inventor: Philip Leslie Drake, Taipei (TW)

Correspondence Address: SUGHRUE MION, PLLC, 2100 PENNSYLVANIA AVENUE, N.W., SUITE 800, WASHINGTON, DC, 20037, US

(73) Assignee: INDUSTRIAL TECHNOLOGY RESEARCH INSTITUTE

(21) Appl. No.: 10/396,479

(22) Filed: Mar. 26, 2003

(51) Int. Cl. B32B 23/02

(52) U.S. Cl. 428/407; 428/403

(57) ABSTRACT

A one-dimensional nanowire and the preparation thereof. The nanowire is self-assembled by at least three building blocks. Each building block comprises a nanoparticle coated with first and second ligands thereon, and the first and second ligands are regionally confined to opposite hemispheres of the nanoparticle. The first ligand is either A or B, and the second ligand is either X or Y; provided that A only reacts with B and X only reacts with Y.

### BACKGROUND OF THE INVENTION

1. Field of the Invention

The present invention relates to a one-dimensional nanowire and the preparation thereof. More particularly, the present invention relates to a one-dimensional nanowire produced in a manner of self-assembly.

2. Description of the Related Arts

Conventional nanowires are made from a variety of methods, usually described as a template approach. For example, a crystallographic step-edge may be utilized and metal atoms deposited along the step-edge. The step acts as a template directing the deposition into long thin nanowires. Another example relates to the use of nanopores. Nanopores are filled with a metal substrate and then the supporting wall is removed to leave a nanowire. However, nanowires produced by these methods have lengths less than 100 nm. In addition, these nanowires are produced in small quantities, and are not suitable for mass production.

Nanoparticles have been shown to behave like molecules in solution and can be self-assembled with the correct chemical conditions into a range of shapes and patterns on the nanometeric and micrometeric as well as molecular levels. It has been reported that the self-assembly of nanoparticles forms 3-dimensional (3D) and 2-dimensional (2D) structures. The 2D structures reported take the form of a monolayer on surfaces. The 3D structures are either composed of multi-layer of 2D structures sequentially built or of a cross-linked solid with no directional order.

### SUMMARY OF THE INVENTION

It is therefore a primary object of the present invention to provide a one-dimensional (1D) self-assembly nanowire with unlimited length. The one-dimensional nanowire is self-assembled by at least three building blocks. Each building block comprises a nanoparticle coated with first and second ligands. The first and second ligands are regionally confined to opposite hemispheres of the nanoparticle. The first ligand is either A or B, and the second ligand is either X or Y. A only reacts with B and X only reacts with Y.

Another object of the present invention is to provide a method for the synthesis of a one-dimensional nanowire in a self-assembly fashion. The method comprises the steps of providing at least three building blocks comprising nanoparticles coated with first and second ligands thereon, wherein the first and second ligands are regionally confined to opposite hemispheres of the nanoparticle, and the first ligand is either A or B, the second ligand is either X or Y, provided that A only reacts with B and X only reacts with Y, and mixing at least two of the building blocks to initiate self-assembly and obtain a one-dimensional nanowire.

### BRIEF DESCRIPTION OF THE DRAWINGS

The present invention will be more fully understood and further advantages will become apparent when reference is made to the following description of the invention and the accompanying drawings in which:

FIG. 1A˜1C are diagrams showing the structures of the nanoparticle and nanowire. FIG. 1A shows a nanoparticle with the regional location of surface ligands; FIG. 1B shows two nanoparticles bound together with the ligands; and FIG. 1C shows a series of 16 nanoparticles forming a nanowire.

FIG. 2A˜2C are diagrams showing the process of producing a nanowire. FIG. 2A shows three basic building blocks; FIG. 2B shows the chemical rules followed by the reaction; and FIG. 2C shows the step-by-step process.

FIG. 3 is a diagram showing a long nanowire created from 250 individual nanoparticles.

### DETAILED DESCRIPTION OF THE INVENTION

During a chemical reaction, millions of molecules are produced in a single solution. The precursors are mixed and the products are formed. It is as easy to make 10 millions molecules as it is to make 10 billion. The reason for this “parallel” production lies in the “directed reactions” of the precursors. They can only react in a single way to provides a single product. They also take advantage of diffusion and mass-transport so that the molecules are constantly colliding but only when they collide in the correct way with the correct energy can they react to form the product. This provides rise to the apparent self-assembly. It appears that the molecules find each other. However, this all occurs in the molecular world where the dimensions are sub nanometric. Using building blocks larger than molecules, connecting or building circuits can be performed in a similar fashion. Simply mixing the components of the circuit together and allowing them to self-assemble provides a microscopic structure.

By producing nanoparticles with the correct chemical functionality and surface distribution, this self-assembly can be controlled and directed. Combining these self-assembled structures with molecular and biological recognition species allows the directed growth of nanowires from predetermined locations and to a desired length or end point.

As mentioned above, the present invention is directed to a one-dimensional self-assembly nanowire with unlimited length. The one-dimensional nanowire is self-assembled by at least three building blocks. Each building block comprises a nanoparticle coated with first and second ligands. The first and second ligands are regionally confined to opposite hemispheres of the nanoparticle. The first ligand is either A or B, and the second ligand is either X or Y. A only reacts with B and X only reacts with Y.

The present invention also features a method for the synthesis of a one-dimensional nanowire in a self-assembly fashion. The method comprises the steps of providing at least three building blocks comprising nanoparticles coated with first and second ligands thereon, wherein the first and second ligands are regionally confined to opposite hemispheres of the nanoparticle, and the first ligand is either A or B, and the second ligand is either X or Y, provided that A only reacts with B and X only reacts with Y; and mixing at least two of the building blocks to initiate self-assembly and obtain a one-dimensional nanowire.

In one embodiment of the method for the synthesis of a nanowire, mixing two different building blocks, of which the first comprises XB coated nanoparticles and the second AX coated nanoparticles. The mixing of the first and second building blocks results in a first mixture comprising a dimmer consisting of two nanoparticles linked by an A-B bond with X ligand on the outer ends.

In a second embodiment of the method for the synthesis of a nanowire, after forming a mixture of dimmers, a third building block comprising YB coated nanoparticles are added to the first mixture. The mixing of the first mixture and the third building blocks results in a second mixture comprising a tetramer consisting of four nanoparticles linked by two XY bonds and one AB bond and with Y ligand on the outer ends.

The “nanowire” of the present invention is defined as a structure composed of linear polymeric chains of nanoparticles. In one embodiment, the “nanoparticles” of the building blocks include, but are not limited to, metal such as Au, Ni, Co, Pt or Fe; metal oxide; semiconductor such as CdS or CdSe; or organic substrate. The diameter of the nanoparticles can be 1 nm to 70 nm; preferably, approximately 10 nm. By controlling the number and diameter of the nanoparticles, the overall length of the nanowire can be controlled precisely from 5 nm to 1000 nm. For lengths greater than 1 μm, it is expected that a size distribution is obtained similar to those seen in standard polymer chemistry; however, it is still possible to produce a nanowire with a length greater than 100 μm.

The “ligand” on the surface of the nanoparticle acts as a stabilizing group protecting the nanoparticle from further reaction. In addition, the ligand has a terminal-end extending away from the nanoparticle core. Selecting an appropriate ligand with a functional group at this location controls the chemistry of the terminal-end. For example, the functional group includes, but is not limited to, amine, alcohol, carboxylic acid, ester, ether, aldehyde, ketone, phenol, halobenzene derivatives, or tosylate derivatives.

In another embodiment, the nanowire further comprises terminal oligonucleotides. The oligonucleotides are not attached to a single nanoparticle, but the end terminal of the nanowire.

In addition, the present invention also features uses of the nanowire as a magnetic, electrical, optical or mechanical component in a sensor, s material, a device or a transducer; and uses of the nanowire as a connector to a biological entity such as cell, cellular organelle, microorganism, virus, protein or enzyme.

Combining the nanoparticles with a chemical or biological recognition species allows the growth from, and connection of, two predetermined locations. The recognition nanoparticle binds to the desired site, it can then be used to sequentially build up nanowires, with the nanowire appearing to grow from the preset locations. When the two nanowires are of suitable length, they can be linked together. This results in the connection of the two surface locations via a directed self-assembly mechanism. This can be performed on a number of different substrates both organic and inorganic, for example, two sites on the surface of a single protein, or on the surface of a printed circuit board or connecting a protein surface to a silicon wafer. Another possibility is the connection to specific locations on a single biological cell, for example, a nerve cell. Using this system, it is possible to connect a nerve cell to a microelectrode with precise control over the point of location.

Without intending to limit in any manner, the present invention will be further illustrated by the following examples.

### EXAMPLE

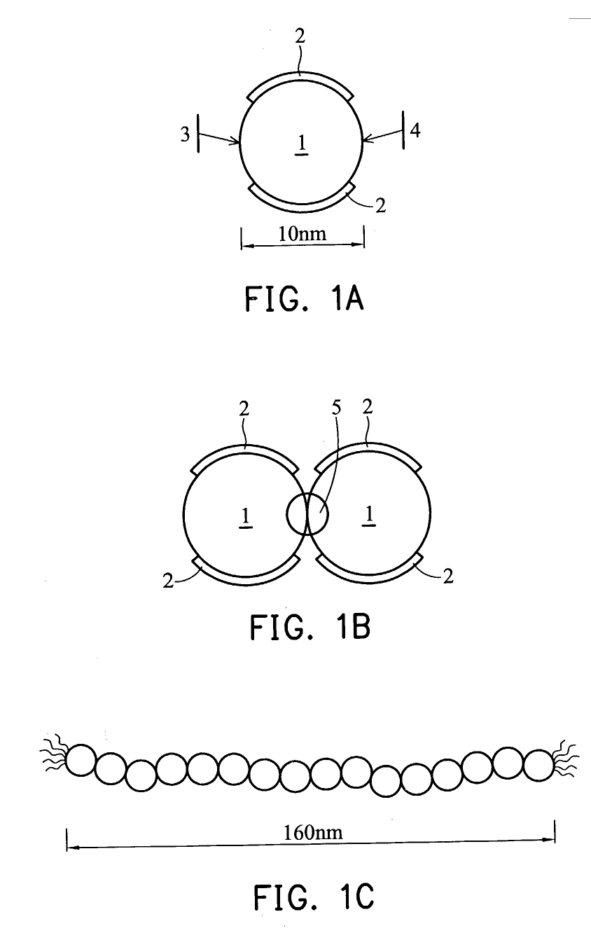

The nanoparticle and nanowire structures are shown in FIGS. 1A˜1C. FIG. 1A shows a nanoparticle 1 with the regional location of surface ligands (2˜4). As mentioned above, the nanoparticle 1 can be metal such as Au, Ni, Co, Pt or Fe; metal oxide; semiconductor such as CdS or CdSe; or organic substrate. The nanoparticle 1 provided here is gold with a diameter of approximately 10 nm. Stabilizing ligands 2, 3, and 4 cover the surface of the spherical nanoparticle 1 to protect the nanoparticle 1 from further reaction. Opposite hemispheres of the nanoparticle 1 are coated with two kinds of ligand. Ligand 3 is X or Y, and ligand 4 is A or B.

Surface chemistry is utilized to create this regional location of the ligands. When bound to a support surface such as a polymer resin, only one half of the nanoparticles are exposed to an external solution. In addition, the point of contact between the nanoparticle and the surface is limited to a small area on the nanoparticle surface. Using conventional surface chemistry, the nanoparticles are attached to a solid support, modified on the exposed side, released from the support, and collected. This results in a nanoparticle having the desired regional location of surface ligands.

When A only reacts with B and X only reacts with Y, two nanoparticles coated with different ligands bond to each other with the ligands as shown in FIG. 1B. The chemical bonding 5 can be a covalent bond between two ligands on different nanoparticles. As a result of the regional location of the ligands, the nanoparticles only link in a head to tail formation. As shown in FIG. 1C, a series of 16 nanoparticles form a nanowire in this manner.

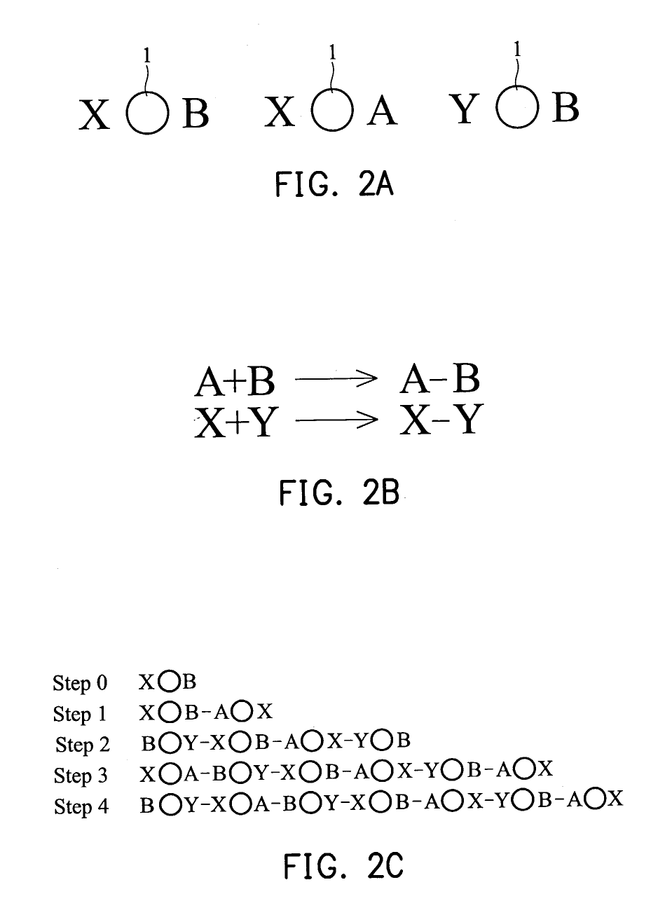

As mentioned above, four kinds of building blocks, XA-, XB—, YA-, or YB-coated nanoparticle can be formed. At least three kinds of building blocks can form a nanowire, for example, XB—, XA- and YB-coated nanoparticles as shown in FIG. 2A. Following the rules shown in FIG. 2B allows self-assembly of the nanowires with precise control over the final length. The building blocks are stored in separate solutions until required, with no reaction occurring. For example, building blocks comprising nanoparticles coated with a combination of the ligands An And X cannot react with each other and thus form a stable solution. Similarly, building blocks comprising nanoparticles coated with a combination of the ligands Y and B cannot react with each other. However, building blocks comprising nanoparticles coated with a combination of the ligands An And B react with themselves, forming a solid precipitate and thus an unstable solution. Mixing the basic building blocks as shown in FIG. 2A in the appropriate order as shown in FIG. 2C effectively grows the nanowires.

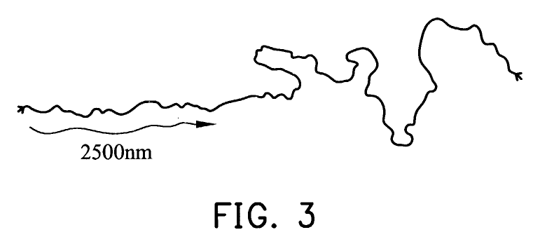

FIG. 2C illustrates steps as follows. At step 0, a solution of XB-coated nanoparticles are provided. At step 1, mixing the XB-coated nanoparticles with AX-coated nanoparticles results in a dimmer consisting of two nanoparticles linked by an AB bond and with ligands X on the outer ends. This is the only possible product and the only possible reaction. Once the reaction is completed, YB-coated nanoparticles are added. Ligands Y of the YB-coated nanoparticles react with the ligands X to form an XY bond. This results in the dimmer becoming a tetramer consisting of four nanoparticles linked by two XY bonds and one AB bond and with ligands Y on the outer ends (step 2). Again this is the only possible reaction and the only possible product, providing a near 100% product yield. As shown in steps 3 and 4, this process can be continued ad infinitum resulting in the growth of nanowires of any desired length. FIG. 3 shows a long nanowire created from 250 individual nanoparticles. Specific examples of A, B, X, and Y are A=aldehyde or ketone, B=1,2-diol, X=carboxylic acid and Y=a primary amine. In this instance, the diol (B) reacts with the aldehyde or ketone (A) to provide an acetal and the primary amine (Y) reacts with the carboxylic acid (X) to provide an amide.

The nanowires produced here can be used as fillers in composite structures changing dielectric properties, as additives for adhesives or drawn out into larger fiber systems, as an electrical contact in microelectromechanical systems (MEMS) and nanodevices. By adding oligonucleotide tags onto the terminal ends of the nanowire, the nanowire can be used to self-attach to specific protein sequences in the body. This allows the electrical connection of single proteins for the applications in biosensor systems or for targeting specific cells in bioelectrical implants such as hearing and optical aids. The nanowires offer the ability to electrically connect single nerve cells with a self-assembling, self-attaching mechanism.

While the invention has been particularly shown and described with the reference to the preferred embodiments thereof, it will be understood by those skilled in the art that various changes in form and details may be made without departing from the spirit and scope of the invention.

What is claimed is:

1. A one-dimensional nanowire self-assembled by at least three building blocks, wherein each building block comprises a nanoparticle coated with first and second ligands thereon, and the first and second ligands are regionally confined to opposite hemispheres of the nanoparticle, the first ligand being either A or B, and the second ligand either X or Y; provided that A only reacts with B and X only reacts with Y.

2. The nanowire as claimed in claim 1, wherein the nanoparticle of the building block comprises metal, metal oxide, semiconductor or organic substrate.

3. The nanowire as claimed in claim 2, wherein the metal is Au, Ni, Co, Pt, or Fe.

4. The nanowire as claimed in claim 2, wherein the semiconductor is CdS or CdSe.

5. The nanowire as claimed in claim 1, wherein the ligand is a functional group comprising amine, alcohol, carboxylic acid, ester, ether, aldehyde, ketone, phenol, halobenzene, tosylate, or derivatives thereof.

6. The nanowire as claimed in claim 5, wherein A=aldehyde or ketone, B=1,2-diol, X=carboxylic acid and Y=a primary amine.

7. The nanowire as claimed in claim 1, the nanowire further comprising a terminal oligonucleotides.

8. A method for the synthesis of a nanowire, comprising the steps of:
providing at least three building blocks comprising a nanoparticle coated with first and second ligands thereon, wherein the first and second ligands are regionally confined to opposite hemispheres of the nanoparticle, and the first ligand is either A or B, the second ligand is either X or Y, provided that A only reacts with B and X only reacts with Y; and
mixing at least two of the building blocks to initiate self-assembly and obtain a one-dimensional nanowire.

9. The method as claimed in claim 8, wherein a first building block comprising XB coated nanoparticles and a second building block comprising AX coated nanoparticles are mixed to result in a first mixture comprising a dimmer consisting of two nanoparticles linked by an A-B bond and with X ligand on the outer ends.

10. The method as claimed in claim 9, wherein a third building block comprising YB coated nanoparticles are added to the first mixture to result in a second mixture comprising a tetramer consisting of four nanoparticles linked by two XY bonds and one AB bond and with Y ligand on the outer ends.

11. The method as claimed in claim 8, wherein the nanoparticle of the building block comprises metal, metal oxide, semiconductor or organic substrate.

12. The method as claimed in claim 11, wherein the metal is Au, Ni, Co, Pt, or Fe.

13. The method as claimed in claim 11, wherein the semiconductor is CdS or CdSe.

14. The method as claimed in claim 8, wherein the ligand is a functional group comprising amine, alcohol, carboxylic acid, ester, ether, aldehyde, ketone, phenol, halobenzene, tosylate, or derivatives thereof.

15. The method as claimed in claim 14, Wherein A=aldehyde or ketone, B=1,2-diol, X=carboxylic acid and Y=a primary amine.

16. The method as claimed in claim 8, further comprising a step of adding a terminal oligonucleotides to the ends of the nanowire.
